(19) United States
(12) Patent Application Publication
(10) Pub. No.: US 2002/0189124 A1
(43) Pub. Date: Dec. 19, 2002

(54) Linear measurement workpiece gripping device

(76) Inventors: Mark Nelson, Eagle Point, OR (US); Thomas G. Simcoe, White City, OR (US)

Correspondence Address: ROBERT D. VARITZ, P.C., 2007 S.E. GRANT STREET, PORTLAND, OR, 97214, US

(21) Appl. No.: 10/227,784

(22) Filed: Aug. 25, 2002

Related U.S. Application Data
(63) Continuation of application No. 09/810,084, filed on Mar. 16, 2001.
(60) Provisional application No. 60/221,290, filed on Jul. 27, 2000.

(51) Int. Cl. G01B 3/10

(52) U.S. Cl. 33/770

(57) ABSTRACT

An attachable/detachable workpiece grip-enhancing device which is removably attachable and detachable in different ways to the trans-axially extending blade in a conventional measuring-tape end element. In one embodiment, central connection structure in the device frictionally attaches to, and detaches from, such a blade under the influence of reversible linear relative translational motion. In another embodiment, attachment is enabled via undirectional relative linear translational movement, and detachment is promoted by either-direction relative rotation between a blade and the device. In a third embodiment, detent-like pseudo-locking attachment takes place.

### CROSS REFERENCE TO RELATED APPLICATIONS

This application is a continuation from application Ser. No. 09/810,084, filed Mar. 16, 2001 for an invention titled “Linear Measurement Workpiece Gripping Device”, which prior application claims priority to Provisional Application Serial No. 60/221,290, filed Jul. 27, 2000, and titled “Linear Measurement Workpiece Gripping Device”. The entire disclosures of each of these two prior applications are hereby incorporated herein by reference.

### BACKGROUND AND SUMMARY OF THE INVENTION

This invention relates to a workpiece gripping (or grip-enhancing) device which is usable on the outer end of an otherwise conventional extensible tape measure. Specifically it relates to such a device which furnishes a special kind of workpiece-gripping surface that eases the single-handed use of measuring tapes under circumstances where the length of measurement being performed causes the user to be out of reach of the outer end of the tape, and where a normal tape-measure end element might unexpectedly slip away from engagement with the workpiece that is being measured. In a more particular sense, the present invention relates to a device of the type just generally described which possesses unique and special attachable/detachable connection structure formed as part of the device, which structure enables easy mounting and demounting of the device on the usual L-shaped (in side profile) tape-end element.

Those who are familiar with various kinds of wood-construction projects know that, with respect to a conventional tape measure, it is common that, on the free end of that measure, there is a small device, generally L-shaped, which includes a trans-axially extending generally planar blade that is intended to catch onto the end or edge of a workpiece during a measurement procedure. The term “trans-axially” employed herein refers to the fact that the blade in such a tape-end element normally extends in a plane which is substantially normal to what can be thought of as the tape's longitudinal long axis.

The present invention, as was suggested above, offers a novel device which can be freely attached and detached to such a tape-end element to enable long-distance measurement, with little likelihood that the outer end of a measuring tape will slip free from the workpiece that is being measured. In the context of providing the grip-enhancing device of this invention, it is important that the device be easily and securely attachable to a tape's outer end element in a manner which will prevent the device from being separated inadvertently from the tape's end element, yet with the device nonetheless being easily removable at any time when so desired.

According to the present invention, three embodiments of which are specifically illustrated and described herein, one of these embodiments takes the form of a generally circular planar structure having a central body portion with a perimeter defined by plural, distributed, tooth-like projections that extend generally normally relative to the plane of the central body portion. Formed in the central body portion is a novel attachment/detachment connection structure which enables the device quickly and easily to be installed removably on the outer end tape element in a conventional measuring tape. In this embodiment of the invention, the connection structure is formed in the central body portion of the device as an elongate, punched-out, belt-loop-like band whose opposite long sides have been sheared clear of the remainder of the device's central body portion. This belt-loop-like configuration forms an appropriate passage for the reversible reception of the blade in a tape-end end element, such as the blade mentioned hereinabove. Installation of the device on a tape-end element is produced by introducing relative translational linear motion between that tape-end device and the belt-loop-like passage, whereby a received blade is held frictionally in place with respect to the attached device. Removal of this form of the device of this invention is performed simply by reversing the direction of motion which was employed to accomplish mounting, with the blade in the tape-end element sliding frictionally free and clear of the device, thus to enable easy separation.

The second embodiment of the invention, which is considered to be the preferred embodiment thereof, possesses all of the structural features just mentioned for the first-discussed embodiment above, and in addition, includes yet another punched-out portion which is punched out to form a generally scoop-like projection effectively centrally within the punched-out belt-loop-like band structure just mentioned above. As will be more fully discussed, the scoop-like structure possesses an angular surface region which can act like a camming ramp surface. This belt-loop-like band structure cooperates to form the same kind of blade-reception passage as was mentioned above. Additionally, this configuration is designed to receive the blade in a conventional tape-end end element of the type which has a central aperture, whereby that aperture engages the scoop-like projection just mentioned to become captured in a kind of edge-to-edge locking contact with the tape-end end element.

Installation of this form of the device of this invention is accomplished in substantially the same manner described earlier for the other device embodiment. However, there is an important different action and behavior which takes place during attachment with respect to this embodiment of the invention, and that is that the scoop-like punched-out projection enters the usual central aperture provided in a tape end element blade. With the two units ready to be inter-connected, inter-connection takes place through introducing linear translational relative motion causing the tape-end element blade to slide into the device's receiving passage and to become caught (latched) therein in the manner just mentioned above.

Separation of these two elements, with respect to this embodiment of the invention, cannot take place by reversing the direction of relative straight translational motion which is employed to attach the two. Rather, with this embodiment of the invention, removal of the device of the invention from the tape-end end element is accomplished by producing relative counter rotation, in either direction, generally about an axis which parallels the long axis of the measuring tape. Such relative rotational motion causes portions of the perimeter edge of the central aperture in the tape end element to ride with a camming-like engagement between this edge structure and the ramp-like surface area of the scoop-like projection, causing enough appropriate material deflection to occur whereby the latched condition between the device and the tape-end element blade is un-done.

The third illustrated embodiment is somewhat like the second, except that here a bump-like domed mound (mound-like region) is punch formed in the belt-loop-like band structure. This mound “pops” into and out of the aperture in a tape end device with a kind of pseudo-locking detent-like action. Installation and removal can be accomplished with various combinations of linear translational and rotational motions.

Various other features and advantages which are offered by the present invention will become more fully apparent as the description that now following is read in conjunction with the accompanying drawings.

### DESCRIPTION OF THE DRAWINGS

FIG. 1 is a fragmentary, simplified side elevation of the outer end of one form of a conventional measuring tape which carries a generally L-shaped end element of one variety typically found on such a tape end.

FIG. 2 is a fragmentary isometric view of the same tape shown in FIG. 1, with dash-double-dot lines illustrating the generally circular outline which represents the use position of a workpiece grip-enhancing device made in accordance with the present invention.

FIG. 3 is somewhat like FIG. 2, except that here one actual embodiment of the present invention is shown attached to the end element in the tape measure of FIGS. 1 and 2.

FIG. 4 is an isometric view taken generally from the far side of FIG. 3, illustrating a view of that side of the device of the invention pictured in FIG. 3, and in a condition non-attached to a tape-end end element.

FIG. 5 is an enlarged, diametral, cross-sectional view of the device of FIGS. 3 and 4 showing portions of the central, generally circular and planar body portion of the device formed with a punch-shifted central region which forms a belt-loop-type connection structure that is provided in this device. The measuring tape is not shown in this view.

FIG. 6 is a front elevation of another embodiment (the preferred embodiment) of a device made in accordance with the present invention.

FIGS. 7 and 8 are enlarged cross-sectional views taken generally along the lines 77 and 8-8 in FIG. 6.

FIG. 9 is a front elevation of another form of tape-end end element, this form having a generally central aperture. FIGS. 6, 7 and 9 collectively help illustrate how the device of FIGS. 6-8, inclusive, may be attached and detached to and from the tape end element pictured in FIG. 9.

FIG. 10 is a view like that presented in FIG. 7, but here showing a third embodiment of the invention.

### DETAILED DESCRIPTION OF THE INVENTION

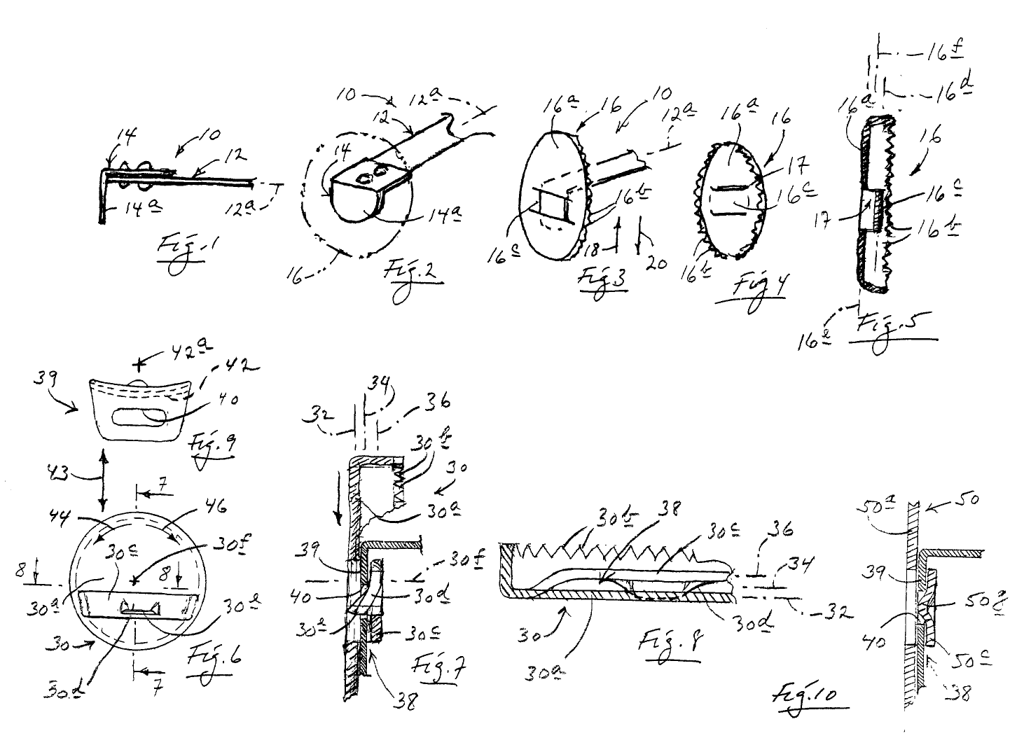

Turning attention to the drawings, and referring first of all to FIGS. 1-5 inclusive, indicated fragmentarily and generally at 10 in FIGS. 1, 2, and 3 is the outer end of a conventional elongate measuring tape. Included in this tape is the usual elongate measuring tape element 12 which has what is referred to herein as a nominal long axis 12a.

Mounted by suitable and conventional attaching structure (see particularly FIGS. 1 and 2), adjacent the outer end (the left end in FIGS. 1, 2 and 3) of tape element 12, is a generally L-shaped, side-profile tape-end end element 14 which includes a down-turned, trans-axially projecting, generally planar blade 14a that nominally occupies a plane which is approximately at a right angle relative to axis 12a.

Focussing attention especially on FIGS. 2-5 inclusive, shown symbolically in dashdouble-dot lines in FIG. 2, and in solid lines in FIGS. 3, 4 and 5, is a workpiece grip-enhancing device 16 which is constructed in accordance with one modification of the present invention.

Device 16 herein, which is a completely unitary and single-material device herein, has a central, substantially circular, and generally planar central body portion 16a, which central portion includes a ringing perimeter of plural, side-by-side adjacent, projecting teeth, such as teeth 16b. In FIG. 3, these teeth, also referred to as tooth-like projections, project somewhat to the right and away from the viewer in FIG. 3. These same teeth project somewhat toward the viewer in FIG. 4, and to the right in FIG. 5.

Formed in any suitable fashion, such as punching and shearing, and located generally centrally in body portion 16a, is an elongate band 16c (see particularly FIGS. 3-5, inclusive). Band 16c is also referred to herein as being part of a belt-loop-like structure, and as also being part of attachment/detachment connection structure. Band 16c is generally planar between its opposite ends, and is disposed generally to occupy a plane shown at 16d in FIG. 5. Plane 16d lies closely spaced from and is substantially parallel to another plane 16e (see FIG. 5) which is generally the plane within which most of central region 16a lies. As can be seen especially in FIGS. 4 and 5, band 16c has been punched-out generally in the direction in which teeth 16b project from the perimeter of central body portion. Further, one can see that where the upper and lower long edges of band 16c have been sheared from the central body portion, a situation exists where band 16c and the remaining (upper and lower) portions of body portion 16a, which portions are also referred to herein both as side regions, and as side regions of adjacency, define a passage 17. Passage 17 effectively lies in another plane 16f that is intermediate planes 16d, 16e. It is this passage, as will now become very apparent, which is adapted, in accordance with the invention, frictionally and slideably to receive a tape-end end element blade, such as blade 14a. In FIG. 3, wherein a condition of device attachment is pictured, one can see that blade 14a extends downwardly through the passage just mentioned to become caught frictionally between band 16c and the just above mentioned side regions in central body portion 16a.

Installation of device 16 with respect to blade 14a takes place through relative translational linear motion between these two components, as indicated generally by upwardly pointing straight arrow 18 in FIG. 3. Detachment of these two components takes place through reverse translational motion, as is indicated by downwardly pointing arrow 20 in FIG. 3.

Turning attention now to FIGS. 6-9, inclusive, indicated generally at 30 in FIGS. 6-8, inclusive, is another form of a workpiece grip-enhancing device which has been constructed in accordance with the present invention. This form of the device is considered to be the preferred embodiment of the invention.

Device 30 includes a generally circular, planar central body portion 30a, and a ringing perimeter of projecting teeth, such as teeth 30b, which are much like previously discussed teeth 16b. In device 30, as was true with respect to the construction of previously mentioned and described device 16, by a punching and shearing action, an elongate band 30c is formed which, as can be seen especially well in FIG. 6, has a somewhat trapezoidal perimeter outline. This trapezoidal outline conveniently accommodates, fittingly, the angled lateral edges of many current tape-end elements such as the one which will shortly be discussed with reference to FIG. 9.

Punched-out generally centrally within band 30c is another punched-out structure 30d which has what is referred to herein as a somewhat scoop-like island structure. The outer surface area of this structure (that surface which faces the viewer in FIG. 6, faces to the left in FIG. 7, and faces downwardly in FIG. 8) is inclined at different shallow angles with respect to the plane containing band 30c. This surface, which is also referred to herein as a camming ramp structure, extends to an edge 30e which faces downwardly in FIGS. 6 and 7. Whereas band 30c is punched-out generally in the direction toward which teeth 30b point, punched-out structure 30d projects in the opposite direction. Band 30c and island 30d constitute portions of attachment/detachment connection structure in device 30.

In device 30, there are three generally parallel and closely spaced planes which are shown at 32, 34, 36 in FIGS. 7 and 8. Plane 32 contains substantially all of central portion 30a, save the central region where the punched-out structures exist. Plane 34 is occupied by portions of punched-out structure 30d, with this plane also substantially containing a passage 38 which lies between body portion 32a and band 30c. It is this passage which is designed to receive another type of conventional tape-end end element which includes a blade with a central aperture. Such a blade is illustrated in FIG. 9 at 39, and its central aperture is shown at 40 in this same figure. Plane 36 is the plane which is substantially occupied by all central portions of band 30c, except punched-out structure 30d.

Returning for just a moment to FIG. 9, the tape-end device which includes blade 39, has an L-shaped side profile and is suitably attached to the outer end of an elongate, extensible measuring tape 42. Tape 42 has a long axis which extends normally into the plane of FIG. 9, and is generally pictured in this figure at the vertical offset location marked 42a. Blade 39 lies in the plane of FIG. 9.

With reference now focussed on FIGS. 6, 7 and 9 collectively, reading FIGS. 6 and 9 together, blade 39 and device 30 are shown separated, and poised for attachment. Such attachment takes place by introducing relative linear translational motion between the blade and the device, as indicated by double-ended straight arrow 43 (which extends vertically between FIGS. 6 and 9), to cause the blade to extend into passage 38. Because of the presence of punched-out structure 30d in band 30c, appropriate slight deflections take place in the central structure of device 30 to allow blade 39 to pass completely into through passage 38. When a correct attached condition is established between the blade and device 30, punched-out structure 30d extends into central aperture 40 in blade 39, with edge 30e positively locking the two connected elements against any disassembly simply by reverse translational motion.

Rather, and according to an important feature of this modification of the invention, detachment of device 30 from a tape-end end-element blade, such as blade 39, can only be accomplished by introducing relative rotational motion, in either direction, of device 30 generally about an axis 30f which substantially parallels tape axis 42a. Such rotational motion possibilities about axis 30f, are illustrated by the two curved arrows 44, 46 provided in FIG. 6. When such relative rotational motion occurs, the ramp surface, or surfaces, of punched-out structure 30d furnish a camming action for interaction between the blade and device 30, which camming action produces an appropriate amount of deflection of band 30c relative to body portion 30a so as to allow the central aperture in the blade to shift free and clear of being caught by edge 30e.

Thus, in this modified form of the invention, an even more secure attachment than that described earlier herein, takes place between a device like device 30, and a blade, like blade 39. Two different kinds of relative motion are therefore necessary to be employed with respect to attaching and detaching such a device.

Turning finally to FIG. 10, which has a point of view like that taken in FIG. 7, shown here generally at 50 is a third form of a workpiece grip-enhancing device which has been constructed in accordance with the present invention. Except with respect to the presence of certain punch-deformed structure which is distinctly and differently present in this form of the invention, all other components of device 50 are essentially the same as similarly located and shaped components in just-described device 30 pictured in FIGS. 6-8, inclusive. Accordingly, number/lower-case designators including the number 50 in FIG. 10 are to be understood, except where pointed out to be different, to be like counterpart components similarly marked with respect to device 30.

Given this large arena of likeness, discussion now proceeds simply with respect to distinguishing structure that sets device 50 distinctly apart from device 30. Thus, formed as by punch deformation generally centrally within elongate band 50c is a kind of bump-like domed mound 50g which projects (to the left in FIG. 10) from band 50c in the same direction that structure 30d projects from band 30c in device 30. In FIG. 10, which illustrates device 50 mounted on blade 39 in a tape end device (from FIG. 9), which blade has previously mentioned central aperture 40, mound 50g is seen to extend into this aperture. Blade 39 as shown in FIG. 10 extends in the same general kind of passage 38 which also exists in device 30 (see FIG. 7). Such a condition produces a kind of pseudo-locked condition between device 50 and blade 39—a condition of “locking” which can be engaged and dis-engaged by various combinations of linear translational and rotational relative motions to produce a kind of detent-like popping into and out of aperture 40 by mound 50g.

Accordingly, device 50 has some of the qualities of behavior found in both of the other embodiments described earlier herein. Namely, device 50, when mounted in place, is held in place by a combination both of frictional engagement between inter-contacting components, and the kind of pseudo-locking through detent action just mentioned.

Accordingly, it will now be appreciated how the novel workpiece grip-enhancing device of this invention meets all of the objectives stated earlier herein. The device is easily mounted and demounted in two different manners of attachment and detachment depending upon the specific invention modification employed. When attached, the device is either held in place strictly by frictional engagement, as with respect to the device shown in FIGS. 1-5, by a kind of positive locking or latching, as with respect to the device shown in FIGS. 6-8, inclusive, or by a detent-like pseudo-locking action as illustrated in FIG. 10.

Thus, while a preferred embodiment, and two modifications, of the present invention have been shown and described herein, it is appreciated that other variations and modifications may be made without departing from the spirit of this invention.

I claim:

1. A selectively attachable/detachable measuring-tape workpiece grip-enhancing device releaseably fittable on and with respect to the trans-axially extending, centrally-apertured, generally planar blade of a conventional measuring-tape end element of the generally L-shaped side-profile variety, said device comprising
a central, generally planar body portion having a perimeter, and
attachment/detachment connection structure formed in said body portion within its said perimeter, adapted latchably and releaseably to receive and attach to such a blade, said connection structure being configured whereby latching attachment to such a blade is preferentially accommodated by relative translational motion between the blade and said connection structure, and unlatching detachment is preferentially accommodated by relative rotation between the blade and said capture structure about an axis which is substantially normal to the nominal plane of the blade.

2. The device of claim 1, wherein said connection structure has a belt-loop-like configuration including an elongate central band occupying one plane, and two offset side expanses disposed adjacent opposite long sides of said band, each of said side expanses occupying another plane which is substantially common to both expanses, and which is spaced from and generally parallel to said one plane, the two regions of elongate adjacency existing between said band and said side expanses at least partially co-defining an open, generally planar, belt-loop-like passage for receiving such a blade, wherein the nominal plane of said passage generally parallels those of said band and said side expanses.

3. The device of claim 2, wherein said band is formed with a contained, generally central, out-of-plane projecting scoop-like island adapted to enter, and to create releasable latching with respect to, the central aperture in a blade received in said passage under circumstances with the device attached to a measuring-tape tape-end element.

4. The device of claim 3, wherein said island is shaped with an outside-surface camming ramp structure that is engagingly co-actible with a passage-received blade to promote and accommodate relative rotational detachment of the device and the blade.

5. The device of claim 1, wherein said central body portion is generally circular, and possesses a ringing perimeter of plural, side-by-side adjacent tooth-like projections.

6. The device of claim 3, wherein said central body portion is generally circular, and possesses a ringing perimeter of plural, side-by-side adjacent tooth-like projections extending, and pointing outwardly, from one side of the nominal plane of the body portion, said band lies on the same side of the nominal plane of said body portion from which said projections extend, and said island projects toward said body portion's nominal plane.

7. A selectively attachable/detachable measuring-tape workpiece grip-enhancing device releasably fittable on and with respect to the trans-axially extending, generally planar blade of a conventional measuring-tape tape-end element of the generally L-shaped side-profile variety, said device comprising
a central, generally circular and planar body portion including a central, generally circular region and a substantially ringing perimeter of tooth-like projections which extend away from one side of the nominal plane of said central region, and
attachment/detachment connection structure formed as a belt-loop-like deformation in said central region, said connection structure being defined by spaced cooperating portions that lie in two, substantially parallel, spaced planes which reside on opposite sides of, and define, a passage which is configured releasably and capturably to receive such a blade as a consequence of relative translational approaching movement created between the connection structure and the blade.

8. The device of claim 7, wherein said connection structure establishes capture of a blade chiefly by sliding frictional engagement.

9. The device of claim 7, wherein said connection structure establishes capture of a blade chiefly by positive latch engagement therewith.

10. The device of claim 7, wherein said connection structure further includes a projecting mound-like region in said belt-loop-like deformation.
